(19) United States
(12) Patent Application Publication
(10) Pub. No.: US 2014/0013262 A1
(43) Pub. Date: Jan. 9, 2014

(54) SYSTEMS AND METHODS FOR PROVIDING PRODUCT INFORMATION

(71) Applicant: Anthony Milostic, Rosehill, NSW (AU)

(72) Inventor: Anthony Milostic, Rosehill, NSW (AU)

(73) Assignee: JAMES HARDIE TECHNOLOGY LIMITED, Dublin 2 (IE)

(21) Appl. No.: 13/812,854

(22) PCT Filed: Jul. 28, 2011
(86) PCT No.: PCT/AU11/00948

§ 371 Date: Sep. 24, 2013

(30) Foreign Application Priority Data
Jul. 29, 2010 (AU) 2010903411

(51) Int. Cl. G06F 3/0481

(52) U.S. Cl. CPC G06F 3/0481
USPC 715/771

(57) ABSTRACT

Described herein are systems and methods for providing product information, and in some embodiments to an interface for providing such information. For example, one embodiment includes a computer implemented method for providing product information. This method includes providing an interface for receiving data indicative of a user-selected primary product and data indicative of a set of job requirements for a job using that primary product. The received data is processed thereby to determine a quantity of a primary product required in respect of the job, and quantities of one or more secondary products required to support the primary product in respect of the job. Output is generated thereby to allow the display of a report indicative of quantity of a primary product required in respect of the job, and quantities of one or more secondary products required to support the primary product in respect of the job. For example, this report may be delivered via a web interface for display in a client browser application. In some embodiments the report provides a basis for cost estimation and/or product ordering functionalities.

### FIELD OF THE INVENTION

The present invention relates to systems and methods for providing product information, and in some embodiments to an interface for providing product estimation and/or ordering functionalities. By way of example, embodiments include computer implemented technologies for delivering such functionalities. Embodiments of the invention have been particularly developed for providing users with access to information regarding a wide range of product types, including construction products such as cladding, flooring and underlay. Whilst some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

In the context of building design and construction, determining the amount of product required for a particular job is a time consuming task. In general terms, it is necessary to determine a quantity of primary product required for the job, as well as quantities of various secondary materials (such as nails, glue and the like) required for the installation/support of the primary product. Often, the required quantities of secondary materials are affected by complex considerations, as opposed to being linearly or predictably related to the quantity of primary material. Associated complications various aspects of the design and construction process, including cost estimation and ordering.

### SUMMARY OF THE INVENTION

It is an object of the present invention to overcome or ameliorate at least one of the disadvantages of the prior art, or to provide a useful alternative.

One embodiment provides a computer implemented method for providing product information, the method including the steps of:

providing an interface for receiving data indicative of a user-selected primary product and data indicative of a set of job requirements for a job using that primary product;

processing data received via the interface thereby to determine a quantity of a primary product required in respect of the job, and quantities of one or more secondary products required to support the primary product in respect of the job; and

providing output for allowing the display of a report indicative of quantity of a primary product required in respect of the job, and quantities of one or more secondary products required to support the primary product in respect of the job.

A method according to claim 1 wherein the interface includes an input for receiving data defined via a user interrogation process.

A method according to claim 2 wherein the user interrogation process is conducted via a browser-based web interface.

A method according to claim 2 wherein the user interrogation process is conducted via software executing at a client terminal.

One embodiment provides a method wherein the user interrogation process includes a plurality of steps, and wherein available selection options for at least one step are affected by selections made in respect of a previous step.

One embodiment provides a method wherein the interface includes an input for receiving a data packet defined based on the creation of a three dimensional job representation data via a modelling software application.

One embodiment provides a method wherein the modelling software application is configured to operate in conjunction with one or more aftermarket software modules for enabling the generation of the data packet.

One embodiment provides a method wherein the interface includes an input for receiving data indicative of a two-dimensional job representation.

One embodiment provides a method wherein the job includes the application of materials to one or more walls, and the data indicative of a set of job requirements includes data indicative of a selection of the following:

dimensions for one or more walls;

dimensions of one or more openings in the one or more walls;

gable characteristics; and

corner characteristics.

One embodiment provides a method wherein the data indicative of a set of job requirements includes an anticipated waste percentage, which controls an allowance for waste by overestimation of product quantities.

One embodiment provides a method wherein the data indicative of a set of job requirements includes data indicative of one or more operational parameters.

One embodiment provides a method wherein the one or more operational parameters include wind loading parameters.

One embodiment provides a method claim wherein the primary product includes a substantially planar construction item, and the secondary products include a selection of the following: nails, screws, glue, flashings, sealant material, membrane material, and paint for supporting a plurality of such construction panels.

One embodiment provides a method wherein the substantially planar construction item includes cladding.

One embodiment provides a method including providing a quote request interface for allowing a user to request a quote based on the job requirements.

One embodiment provides a method wherein the quote request interface is responsive to the user request for providing data indicative of the job requirements to a product vendor.

One embodiment provides a method the product vendor is selected based on a characteristic of the user that defined the job requirements.

One embodiment provides a method including providing a facility for allowing a user to maintain a cost library, thereby to allow cost calculations in respect of the job requirements.

One embodiment provides a method including providing an ordering interface for allowing a user to place an order based on the job requirements.

A method for providing product information, the method including:

providing tools for the incorporation of set of physical construction products in a three dimensional modelling software application.

One embodiment provides a method wherein the set of physical construction products include cladding products.

One embodiment provides a method including a step of processing data indicative of a three dimensional model created by a user, the model including one or more of the physical construction products, thereby to determine quantity of a primary product required to physically construct the model, and quantities of one or more secondary products required to support the primary product in respect of physical construction of the model.

One embodiment provides a method wherein the method additionally includes providing an interface for allowing a user to request a quote or place an order in respect of the determined quantities of primary and secondary products.

One embodiment provides a computer implemented method for providing product information, the method including the steps of:

providing a download facility for allowing a user to download a set of three dimensional objects representative of one or more cladding products, such that the user is enabled to use those objects when constructing a building model in a CAD software application;

providing an interface for receiving data indicative of the building model constructed by the user;

processing the received data thereby to determine a quantity of the one or more cladding products required thereby to construct a physical manifestation of the building model;

processing the received data thereby to determine one or more secondary products required to support the cladding products, wherein the secondary products include any one or more of nails, screws, glue, flashings, sealant material, and membrane material, and required quantities for the one or more secondary products;

providing output for allowing the display of a report indicative of the quantity of cladding product required to construct a physical manifestation of the building model, and the determined quantities the secondary products required to support the cladding product for the construction of a physical manifestation of the building model.

One embodiment provides a computer implemented method for providing product information, the method including the steps of:

providing an interface for receiving data indicative of a user-selected cladding product and data indicative of a set of job requirements for a job using that cladding product, wherein the job requirements include dimensions for one or more walls, dimensions for one or more openings in the one or more walls, and a frame type;

processing the data indicative of job requirements thereby to determine one or more secondary products required for the job, wherein the secondary products include any one or more of nails, screws, glue, flashings, sealant material, and membrane material, for supporting the cladding product;

processing data received via the interface thereby to determine a quantity of the cladding product required in respect of the job, and quantities for each of the determined secondary products required to support the cladding product in respect of the job; and

providing output for allowing the display of a report indicative of the quantity of cladding product required in respect of the job, and the determined quantities the secondary products required to support the cladding product in respect of the job.

One embodiment provides a computer implemented method for providing product information, the method including the steps of:

providing an interface for receiving data indicative of a user-selected primary product and data indicative of a set of job requirements for a job using that primary product;

processing data received via the interface thereby to determine a quantity of a primary product required in respect of the job, and quantities of one or more secondary products required to support the primary product in respect of the job; and

providing output for allowing the display of a report indicative of quantity of a primary product required in respect of the job, and quantities of one or more secondary products required to support the primary product in respect of the job.

A computer implemented method for providing product information, the method including the steps of:

providing a download facility for allowing a user to download a set of three dimensional objects representative of one or more primary construction products, such that the user is enabled to use those objects when constructing a building model in a CAD software application;

providing an interface for receiving data indicative of the building model constructed by the user;

processing the received data thereby to determine a quantity of the one or more primary construction products required thereby to construct a physical manifestation of the building model;

processing the received data requirements thereby to determine one or more secondary products required to support the primary construction products, and required quantities for the one or more secondary products;

providing output for allowing the display of a report indicative of the quantity of primary construction product required to construct a physical manifestation of the building model, and the determined quantities the secondary products required to support the primary construction product for the construction of a physical manifestation of the building model.

One embodiment provides a computer system including a web server configured to deliver a web based interface to a plurality of user terminals, wherein the web server is configured to perform a method as described herein

One embodiment provides a computer system including a microprocessor configured to perform a method as described herein.

One embodiment provides a tangible non-transient computer readable medium carrying executable code that when executed on one or more microprocessors of a computer system cause the computer system to perform a method as described herein.

One embodiment provides a computer program product configured for allowing the performance of a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

Preferred embodiments of the invention will now be described, by way of example only, with reference to the accompanying drawings in which:

FIG. 1 schematically illustrates a product calculator framework according to one embodiment.

FIG. 2 illustrates a method according to one embodiment.

FIG. 3 provides a system level overview according to one embodiment.

FIG. 4 illustrates a method according to one embodiment.

FIG. 5A illustrates a client terminal according to one embodiment.

FIG. 5B illustrates a client terminal according to one embodiment in combination with a product calculator framework according to one embodiment.

### DETAILED DESCRIPTION

Described herein are systems and methods for providing product information, and in some embodiments to an interface for providing such information. For example, one embodiment includes a computer implemented method for providing product information. This method includes providing an interface for receiving data indicative of a user-selected primary product and data indicative of a set of job requirements for a job using that primary product. The received data is processed thereby to determine a quantity of a primary product required in respect of the job, and quantities of one or more secondary products required to support the primary product in respect of the job. Output is generated thereby to allow the display of a report indicative of quantity of a primary product required in respect of the job, and quantities of one or more secondary products required to support the primary product in respect of the job. For example, this report may be delivered via a web interface for display in a client browser application. In some embodiments the report provides a basis for cost estimation and/or product ordering functionalities.

The present embodiments will primarily be described by reference to primary products in the form of cladding. However, this should not be regarded as limiting in any way, with other embodiments being directed to the likes of flooring, piping, roofing, insulation and other general construction products.

### Product Calculator Framework

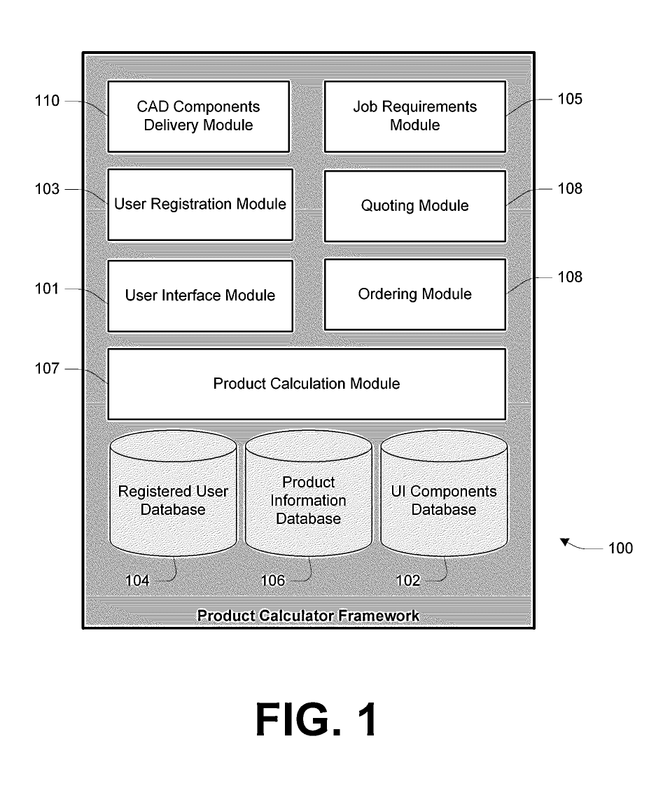

FIG. 1 provides a schematic overview of a product calculator framework 100. This framework is conceptually split into a number of logical components, which need not be physically separated. For example, these components may be collectively provided by one or more software applications executing on one or more computing platforms (optionally distributed platforms). It should be appreciated that not all of these logical components are present in all embodiments.

Framework 100 includes user interface module 101, which in conjunction with a User Interface (UI) components database 102 provide data and logic for driving a user interface. For example, this user interface may be web-delivered for rendering within a client web-browser application, as discussed further below. From a functional standpoint, the user interface module provides the requisite functionalities for displaying information to a user, and for receiving input from a user.

A user registration module 103 operates in conjunction with a registered user database 104 for providing a process whereby a user registers to use framework 100. For example, a user provides various aspects of personal information, and is associated in database 104 with a username and password thereby to allow identification of the user. In some embodiments there are multiple classes of user, with varied ranges of functionalities being available to the various classes of user. Database 104 additionally maintains a record of user activity, for example job requirements previously inputted by a given user. This allows a user to re-open and review previously submitted jobs, including partially submitted jobs.

A job requirements module 105 is configured to receive data indicative of a user-selected primary product and data indicative of a set of job requirements for a job using that primary product.

The degree of specificity in relation to the user-selected primary product varies between embodiments, depending for example on the breadth of the framework. For example, in one embodiment selecting a primary product includes first selecting a product category (for example cladding, flooring, piping, etc) and then selecting a specific product line (for example a particular line of cladding product).

The manner by which module 105 receives data indicative of a set of job requirements varies between embodiments. In the present example, the interface includes an input for receiving data defined via a user interrogation process, conducted via interaction of a user of a client terminal with components delivered by module 101. That is, a web-delivered interface asks a user to make various selections and/or respond to various questions, thereby to provide input indicative of a set of job requirements. In other embodiments the interface additionally or alternatively includes an input for receiving a data packet defined based on the creation of a three dimensional job representation data via a modeling software application, or an input for receiving data indicative of a two-dimensional job representation. These options are discussed in more detail further below.

In some embodiments job requirements module 105 operates in conjunction with a product information database 106. By way of example, the user interrogation process includes a plurality of user-selections. In some cases available selection options for at least one user selection are affected by previous selections. That is, logic implemented within module 105 processes a user selection on the basis of information contained within database 106 thereby to determine which of a range of potential selections are appropriate for a particular situation, and only present those to the user as available options. For example, in one embodiment a user inputs data indicative of operation parameters (such as wind loading) and module 105 determines, based on the selected primary product, categories of fixing products suitable for the job in question (nail types, etc).

Following receipt of the job requirements, a product calculation module 107 operates in conjunction with database 106 thereby to determine a quantity of a primary product required in respect of the job, and quantities of one or more secondary products required to support the primary product in respect of the job, and provide output indicative of a report. This enables module 101 to display of a report indicative of quantity of a primary product required in respect of the job, and quantities of one or more secondary products required to support the primary product in respect of the job.

The term “support” is presently used in a general sense, and should not be read as limited to structural support. That is, the term is intended describe a range of secondary product types that are used in the context of installing the primary product.

Framework 100 additionally includes a quoting module 108 for allowing a user to obtain pricing information in respect of a job. This presently includes a quote request interface for allowing a user to request a quote based on the job requirements. The quote request interface is responsive to the user request for providing data indicative of the job requirements to a product vendor. This vendor then prepares a quote, and provides this to the user (optionally via framework 100). In the present embodiments, the product vendor is selected based on a characteristic of the user that defined the job requirements. For instance, database 102 maintains data indicative of the user's locality, and a product vendor servicing that locality is selected.

In some embodiments module 108 additionally provides a facility for allowing a user to maintain a cost library, thereby to allow cost calculations in respect of the job requirements. For example, a user inputs costs for various primary and secondary products from previously obtained quotes, thereby to allow a rough estimation of overall cost without having to obtain a formal quote from a vendor. Data indicative of a give user's cost library is maintained in database 104. In some embodiments module 108 includes additional functionality to allow estimation of labor requirements for the installation of products in respect of the job.

In some embodiments framework 100 includes an ordering module 109 for allowing a user to place an order based on the job requirements. This may be supplemental to or independent of module 108. That is, in some cases the ordering module is accesses based on an existing response from module 108, whilst in other cases module 109 is accessed without first obtaining a quote.

Although the availability of an ordering module such as module 108 is fairly common in the context of web-delivered interfaces, this has particular significance in the context of CAD software add-on embodiments, which are discussed further below. As an overview of such embodiments, framework 100 includes a CAD components deliver module 110 for allowing the download of CAD components by users. A user downloads and installs such components thereby to provide additional functionality to an existing CAD application (such as ArchiCAD or Revit). This additional functionality includes template objects representative of primary products (in look, shape and size) which are readily imported into design models. In some embodiments such design models are then used as basis for input to module 105, and allow integration with other components of framework 100 (for example to allow a user of a CAD program to request a quote for primary and secondary products required to physically construct the design represented in a model.

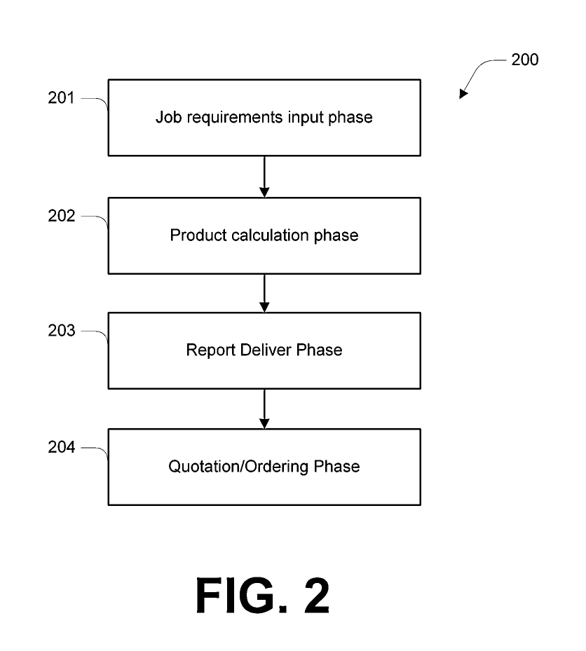

In some embodiments framework 100 is used to perform method 200 of FIG. 2. For example, computer executable code maintained on one or more carrier media accessible to framework 100 is executed on one or more processors accessible to framework 100 thereby to enable performance of such a method. Method 200 includes a job requirements input phase 201, which includes receiving data indicative of a user-selected primary product and data indicative of a set of job requirements for a job using that primary product. The received data is processed at a product calculation phase 202 thereby to determine a quantity of a primary product required in respect of the job, and quantities of one or more secondary products required to support the primary product in respect of the job. Output is generated at report delivery phase 203 thereby to allow the display of a report indicative of quantity of a primary product required in respect of the job, and quantities of one or more secondary products required to support the primary product in respect of the job. For example, this report may be delivered via a web interface for display in a client browser application. In some embodiments the report provides a basis for cost estimation and/or product ordering functionalities at quotation/ordering phase 204. More detailed examples of methods based on method 200 are discussed further below.

### Exemplary System-Level Overview

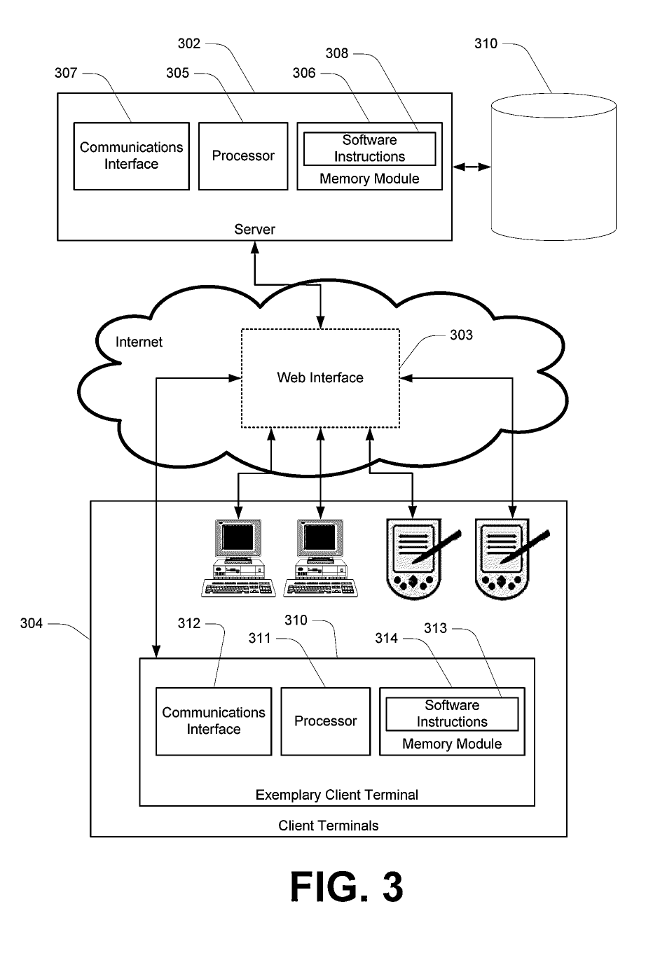

In some embodiments, methods and functionalities considered herein are implemented by way of a server, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310 (which may provide the functionality of any one or more of databases 103, 105 and 106), which in some embodiments includes a plurality of distributed storage locations. In further embodiments the database leverages memory module 306. Database 310 maintains a data indicative of employer profiles and jobseeker profiles (including data for allowing the viewing of both public and private profiles).

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Exemplary Web-Based Job Requirements Input Process

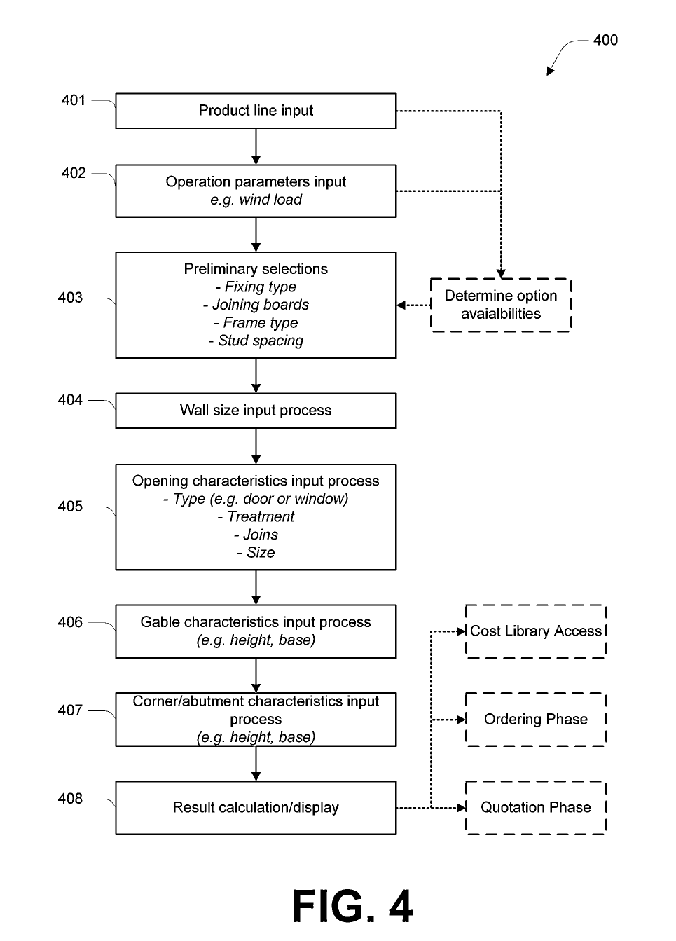

FIG. 4 illustrates an exemplary web-based job requirements input process, in the form of method 400. Method 400 is performed by framework 100, for example in the context of a system level arrangement, such as that described above by reference to FIG. 3. The sequencing of steps should not be regarded as limiting, and in some cases it is possible for a user to perform steps in varied orders.

In overview, method 400 describes an exemplary process by which a user inputs job requirements via a web-based interface in relation to cladding products. Although cladding products are used for the purposes of this example, that should not be regarded as necessarily limiting on other embodiments.

Step 401 includes a product line input process, whereby a user selects a particular cladding product. For example, a drop-down menu is presented. In some embodiments, upon selection of a particular product via the drop down menu, additional information regarding that product (such as look, uses and the like) is presented to the user.

Step 402 includes the input of operation parameters. These include parameters affecting the job as a whole, such as the likes of wind loading (based on a standard such as AS 4055). Input from this step combines with input from step 401 thereby to affect available selection options at a preliminary selection step 403. For example, step 403 may include selections in relation to fixing types, joining boards, frame types and stud spacing. One or more of these selections may be affected by selections made at steps 401 and 402. In this regard, framework 100 makes use of logic provided by module 105 and information in database 106 thereby to present a set of appropriate selection options.

Although the present disclosure makes reference to particular standards, such as AS 4055, that should not be regarded as limiting in any way. Furthermore, in some embodiments, framework 100 is configured to provide information based on a range of distinct standards, and a particular standard is selected in for a given task either by a user, or by an automated process based on characteristics of a user. For instance, in some cases standards vary between jurisdictions, and a standard appropriate for a user's jurisdictions is selected either by the user, or automatically based on knowledge of a jurisdiction in which the user is based.

Step 404 includes a process for inputting wall sizes (in terms of height and length). Walls are input one-by-one, and saved in a table (which is optionally displayed to a user via the web interface). Once the user has entered all desired walls, the user progresses to step 405, which is a similar process but relating to openings. Openings are described in terms of type (e.g. door or window), size, treatment type, and join types. Once the user has entered all desired openings, the user progresses to step 406.

Step 406 allows a user to input data indicative of gable characteristics (such as height and base). This is complemented by step 407, which allows a user to input corner/abutment characteristics. Once again, this is a repetitive process much like those for walls and openings, whereby corners are added one-by-one.

Once steps 401 to 407 are complete, a user is provided with a report at step 408. This report summarizes the job requirements provided by the user (optionally simplified in terms of total areas and the like) and the quantities of primary and secondary products required for the job. One embodiment provides quantities for secondary products in the form of nails, screws, glue, flashings, sealant material, membrane material, and paint. Other embodiments provide greater or fewer categories of secondary products.

As noted, a method similar to method 400 is optionally implemented for other categories of primary product. In this regard, the table below provides an indication as to information sought and secondary product categories for a range of primary products.

| Primary Product | Secondary Products | Input Required |
|---|---|---|
| Cladding | Nails/screws/glue | Specific cladding type |
| | Flashings | Wind loading |
| | Sealant material | Fixing type |
| | Membrane material | Joining board type. |
| | Paint | Frame type. |
| | | Stud spacing. |
| | | Wall characteristics. |
| | | Opening characteristics. |
| | | Gable characteristics. |
| | | Corner characteristics. |
| Flooring | Underlay | Frame type |
| | Fixings | Ceiling type |
| | Glue | Floor area |
| | | Room shape |
| Piping | T-Junctions | Installation |
| | Bends | configuration/conditions |
| | Adaptors | Load types |
| | Reducers | Flow rates |
| | Saddles | Locality (e.g. with a pull down |
| | Stormwater pits | menu for locally applicable |
| | Gulleys | standards & codes) |
| | Headwalls | |
| | Drain grates | |
| | Pollutant traps | |

It will be appreciated that this is indicative only, and deviations are present in various embodiments.

### Cad-Based Product Calculation Functionalities

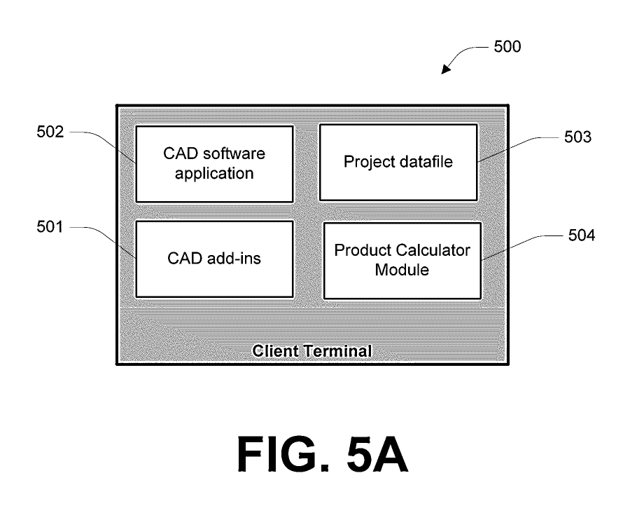

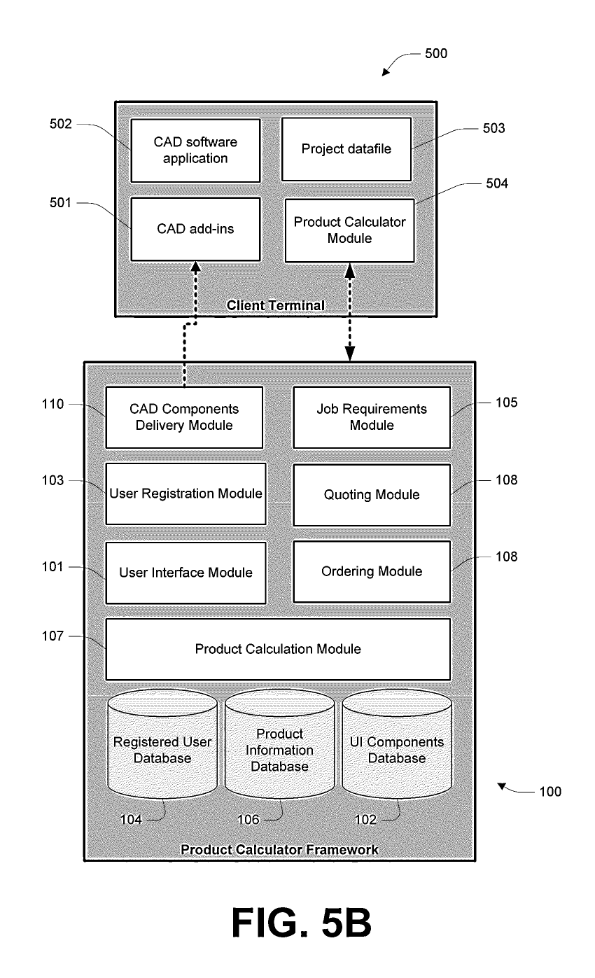

One embodiment provides a method for providing product information, the method including providing tools for the incorporation of set of physical construction products in a three dimensional modeling software application, such as a CAD application. These tools are optionally made available for download from a web facility such as framework 100, or otherwise delivered (for example on computer readable media). FIG. 5A illustrates a client terminal 500 including such a tools, in the form of CAD add-ons 501. These are installed to enhance the functionality of an existing CAD software application 502, such as ArchiCAD or Revit.

The CAD add-ons include pre-made objects that represent the look and dimensions of construction products, such as cladding products. This allows a user of the CAD application to apply those products to an in-progress design, which is stored on client terminal 500 as a datafile 503. For example, in one embodiment a user selects a wall in the model to which cladding products are to be applied, selects a cladding product from a list of available products, and makes various preliminary selections. The add-on then applies the relevant cladding product to the virtualized wall.

In some embodiments the CAD add-ons are configured to operate in conjunction with product calculation functionalities, such as those provided via framework 100. This is optionally achieved by way of data and logic maintained locally at terminal 500, or by way of interaction with framework 100 via an Internet connection. For example, as shown in FIG. 5B, a user downloads CAD add-ons 501 from framework 100 via module 110. Installation of these components provides a product calculator module on client terminal 500, which interacts with various components of framework 100. For example, this may include:
Providing data to framework 100, thereby to allow a user to interact with framework 100 via a web-browser at a later stage, with some or all aspects of job requirement data having been pre-populated based on analysis of products used in the context of datafile 503.
Providing interactive objects via CAD application 502, or other proprietary software executing on terminal 500, thereby to provide a user with functionality similar to that provided via a browser-based interface as described further above. In some cases this allows a user to request a quotation for (and/or order) primary and secondary products required for a CAD design directly or semi-directly from the CAD software.

In either case, a software module is responsible for processing data indicative of a three dimensional model created by a user, the model including one or more of the physical construction products, thereby to determine quantity of a primary product required to physically construct the model, and quantities of one or more secondary products required to support the primary product in respect of physical construction of the model. This optionally extends to providing an interface for allowing a user to request a quote or place an order in respect of the determined quantities of primary and secondary products.

In some embodiments further software is provided for allowing the utilization of 2D plans for providing input to module 105 in the context of framework 100. This allows a relatively simplified graphical arrangement for providing data to framework 100.

### CONCLUSIONS

It will be appreciated that the disclosure above provides various novel and inventive systems and methods for providing product information. It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

The claims defining the invention are as follows:

1. A computer implemented method for providing product information, the method including the steps of:
providing a download facility for allowing a user to download a set of three dimensional objects representative of one or more cladding products, such that the user is enabled to use those objects when constructing a building model in a CAD software application;
providing an interface for receiving data indicative of the building model constructed by the user;
processing the received data thereby to determine a quantity of the one or more cladding products required thereby to construct a physical manifestation of the building model;
processing the received data thereby to determine one or more secondary products required to support the cladding products, wherein the secondary products include any one or more of nails, screws, glue, flashings, sealant material, and membrane material, and required quantities for the one or more secondary products; and
providing output for allowing the display of a report indicative of the quantity of cladding product required to construct a physical manifestation of the building model, and the determined quantities the secondary products required to support the cladding product for the construction of a physical manifestation of the building model.

2. A computer implemented method for providing product information, the method including the steps of:
providing an interface for receiving data indicative of a user-selected cladding product and data indicative of a set of job requirements for a job using that cladding product, wherein the job requirements include dimensions for one or more walls, dimensions for one or more openings in the one or more walls, and a frame type;
processing the data indicative of job requirements thereby to determine one or more secondary products required for the job, wherein the secondary products include any one or more of nails, screws, glue, flashings, sealant material, and membrane material, for supporting the cladding product;
processing data received via the interface thereby to determine a quantity of the cladding product required in respect of the job, and quantities for each of the determined secondary products required to support the cladding product in respect of the job; and
providing output for allowing the display of a report indicative of the quantity of cladding product required in respect of the job, and the determined quantities the secondary products required to support the cladding product in respect of the job.

3. A method according to claim 2 wherein the data indicative of a set of job requirements includes an anticipated waste percentage, which controls an allowance for waste by overestimation of primary and secondary product quantities.

4. A method according to 2 or claim 3 wherein the interface includes a web-based interface for receiving data defined via a user interrogation process, wherein the user interrogation process includes a plurality of steps, and wherein available selection options for at least one step are affected by selections made in respect of a previous step.

5. A method according to claim 4 wherein one of the steps in the user interrogation process includes identifying wind loading characteristics, and wherein the wind loading characteristics affect selection availability for one or more secondary products in the form of nails, screws, and glue for a subsequent step in the user interrogation process.

6. A method according to claim 2 wherein the data indicative of job requirements includes data indicative of gable characteristics and corner characteristics, and the secondary products include products required for the construction of corners and gables in accordance with the job requirements.

7. A method according to claim 2 wherein the interface includes an input for receiving a data packet defined based on the creation of a three dimensional job representation data via a modelling software application, wherein the modelling software application is configured to operate in conjunction with one or more aftermarket software modules for enabling the generation of the data packet, the software modules including a module for determining a quantity of a cladding product represented in the three dimensional job representation data.

8. A method according to claim 2 wherein the data indicative of job requirements includes data indicative of one or more operational parameters, and wherein determining the one or more secondary products required for the job is responsive to the operational parameters.

9. A method according claim 2 including providing a quote request interface for allowing a user to request a quote based on the job requirements.

10. A computer implemented method for providing product information, the method including the steps of:
providing an interface for receiving data indicative of a user-selected primary product and data indicative of a set of job requirements for a job using that primary product;
processing data received via the interface thereby to determine a quantity of a primary product required in respect of the job, and quantities of one or more secondary products required to support the primary product in respect of the job; and
providing output for allowing the display of a report indicative of quantity of a primary product required in respect of the job, and quantities of one or more secondary products required to support the primary product in respect of the job.

11. A computer implemented method for providing product information, the method including the steps of:
providing a download facility for allowing a user to download a set of three dimensional objects representative of one or more primary construction products, such that the user is enabled to use those objects when constructing a building model in a CAD software application;
providing an interface for receiving data indicative of the building model constructed by the user;
processing the received data thereby to determine a quantity of the one or more primary construction products required thereby to construct a physical manifestation of the building model;
processing the received data thereby to determine one or more secondary products required to support the primary construction products, and required quantities for the one or more secondary products;
providing output for allowing the display of a report indicative of the quantity of primary construction product required to construct a physical manifestation of the building model, and the determined quantities the secondary products required to support the primary construction product for the construction of a physical manifestation of the building model.

12. A computer system including a web server configured to deliver a web based interface to a plurality of user terminals, wherein the web server is configured to perform a method according to any one of claims 1 to 11.

13. A computer system including a microprocessor configured to perform a method according to any one of claims 1 to 11.

14. A tangible non-transient computer readable medium carrying executable code that when executed on one or more microprocessors of a computer system cause the computer system to perform a method according to any one of claims 1 to 11.

15. A computer program product configured for allowing the performance of a method according to any one of claims 1 to 11.
